(19) United States
(12) Patent Application Publication
(10) Pub. No.: US 2024/0350337 A1
(43) Pub. Date: Oct. 24, 2024

(54) A Bed for Turning Patients

(71) Applicant: Burling Aged Care Solutions PTY LTD, New South Wales (AU)

(72) Inventors: Anthony Burling, New South Wales (AU); Tracy Burling, New South Wales (AU)

(21) Appl. No.: 18/686,960

(22) PCT Filed: Aug. 16, 2022
(86) PCT No.: PCT/AU2022/050898

§ 371 Date: Feb. 27, 2024

(30) Foreign Application Priority Data
Sep. 8, 2021 (AU) 2021902910

(51) Int. Cl. A61G 7/00; A61G 7/005; A61G 7/008; A61G 7/012; A61G 7/015; A61G 7/018

(52) U.S. Cl. CPC A61G 7/001; A61G 7/005; A61G 7/008; A61G 7/012; A61G 7/015; A61G 7/018; A61G 2200/327

(57) ABSTRACT

A bed adapted for turning a supine patient, the bed comprising a horizontal surface adapted for receiving a mattress. The horizontal surface comprises a first panel and a second panel extending along the length of the surface, wherein each panel can selectively incline by at least one actuator and wherein when one of the panels is inclining, the inclining panel allows for lateral rotation of supine patient onto their respective side.

### TECHNICAL FIELD

The present invention relates to a medical assistive device, more particularly, a bed for laterally rotating a supine resident or patient onto their respective side.

### BACKGROUND

Medical complications are common from immobility among elderly patients or aged care residents who are bedbound, have compromised core strength and may be difficult to reposition. One of the major methods for prevention of medical complications such as pressure injuries for example, is the frequent manual repositioning of immobile patients. It is generally recommended that the standard of care for bedbound patients are to be repositioned every two hours. In wards of bedbound patients, to ensure that the standard of care, a nurse or a caretaker has to go around each individual patient to manually reposition them. For most bedbound patients, repositioning is a very time-consuming task and has to done at a pace that is also considered as comfortable for the patient as they can do. So, in large wards of bedbound patients, it can be appreciated that by the time that the last bedbound patient is repositioned, it may be two hours already from the repositioning of the first bedbound patient, and the nurse or caretaker has to rush back to the first bedbound patient and reposition them again, leaving hardly any time for the nurse or caretaker to rest when fulfilling their repositioning duties. Currently, the manual process for turning residents/patients within their beds may result in skin tears, pressure injuries from insufficient turning regimes (largely linked to workload) and manual handling injuries for care staff.

Designs have been developed to address the above concerns. For example, U.S. Pat. No. 9,248,063 describes a device for turning over and transferring the patient. This device uses a sling to raise one side of the bed-shaped mattress and lower the other side of the bed-shaped mattress. A disadvantage of using slings is that it requires properly attaching or someone to hook onto the pad lugs to ensure the patient can be raised safely. As different patients have different weights, the device may struggle to raise a heavier person compared to a lighter person. A further disadvantage of hooking the pad lugs is that it may also introduce a possible source of human error.

For example, U.S. Pat. No. 6,321,398 describes a body-turn-over apparatus with a driving mechanism that drives a displacement shaft of the driven assembly to move or rotate, so that ropes hanging from two ends of the driven assembly to connect the net are alternately pulled up and lowered, helping a patient lying on the net to regularly turn over or lie on side to avoid bedsores. The vibrator may alternately pull and lower ropes connected to two sides of the net at high frequency. This apparatus allows for the patient lying on the net to lie on the side for the nurse to easily complete back cleaning or changing a continence aide. This is for short term movement as it will be uncomfortable for a patient to stay on the side with the net acting as the back's support. Since the bed does not incline, it does not support the back of the patient when they are on the respective side.

Current devices for turning a bedbound patient may include some disadvantages relating to not distributing the patient's weight when they are inclined or on their side. In light of the aforementioned disadvantages, there exists a long-felt need to provide a bed with inclinable panels so that the inclining panel may allow for lateral rotation of supine patient onto their respective side, that may overcome one or more shortcomings of patient turning apparatuses as described in the prior art.

Any discussion of the prior art throughout the specification should in no way be considered as an admission that such prior art is widely known or forms part of common general knowledge in the field.

### SUMMARY

### Problems to be Solved

It may be an advantage to provide a bed with inclinable panels to assist a nurse or a caretaker to laterally rotate a supine patient with restricted/limited mobility so that the nurse or the caretaker can minimise injury from physical overexertion when laterally rotating patients.

It may be an advantage to provide a bed that is height adjustable to the floor so that the immobile patient can easily get onto the bed or off the bed at a lower configuration, and the supine patient can be comfortably resting away from the floor at an elevated configuration.

It may be an advantage to provide inclinable panels that supports the back of the supine patient as they are laterally rotated to their side.

It may be an advantage to provide side rails securable to the edge of the left panel and the edge of the right panel for a supine patient to hold when they are turning to the side and/or getting onto or off the bed.

It may be an advantage to provide an inclinable upper panel for inclining the patient's upper body so that they can be assisted to a relaxed position and/or towards an upright position.

It may be an advantage to provide one actuator for inclining each panel and also to adjust the height of the horizontal surface.

It may be an advantage to provide a different actuator for inclining each panel as a specific actuator may have simpler mechanisms for inclining a specific panel.

It may be an advantage to provide a mattress that is flexible so that it can support the supine patient's back as the panel is inclining to the desired angle.

It may be an advantage to provide a support frame that is sturdy to support the weight of the supine patient.

It may be an advantage to provide a controller that is communicable with the actuator so that a nurse or a caretaker can adjust the inclination of the bed and/or the height of the bed.

It may be an advantage to provide controllers at the side rails, which will be proximal to the supine patient's hands for a patient to easily adjust to their desired inclination. It may be an advantage to provide a sensor or a group of sensors to the bed to determine whether a patient is on the bed or not so that the inclination of the panel requires the other panels to be level to the horizontal support.

It may be an advantage to provide the sensor that is communicable to the actuator such that when a panel is inclining, it disables the actuation of the other panels so that the patient does not become squashed between two inclined panels.

It may be an advantage to provide a controller that is in wireless communication with the actuator or actuators so that there is less wires near the bed and to minimise tripping hazards.

It may be an advantage to provide the inclination of the panels at a rate between 2° to 8° per second so that it allows the patient time to react or hold onto the side rails or side supports.

It may be an advantage to provide the angle of inclination of the left panel or the right panel to the length of the horizontal surface between 180° to 90° so the patient can be repositioned comfortably at a desired angle between supine and on their side.

It is an object of the present invention to overcome or ameliorate at least one of the disadvantages of the prior art, or to provide a useful alternative.

### Means for Solving the Problem

A first aspect of the present invention may relate to a bed adapted for turning a supine patient, the bed may comprise a horizontal surface adapted for receiving a mattress. The horizontal surface may comprise a first panel and a second panel extending along the length of the surface, wherein each panel may selectively incline by at least one actuator and wherein when one of the panels may be inclining, the inclining panel may allow for lateral rotation of supine patient onto their respective side.

Preferably, the actuator may incline each panel above the level of the horizontal surface such that the angle between the first panel and the second panel may be between 180° to 90°.

Preferably, the at least one actuator may incline one of the panels when the other panel may be level to the horizontal surface.

Preferably, the rate of inclining one of the panels may be between 2° to 8° per second.

Preferably, the mattress may be flexible.

Preferably, the bed may further comprise a first side rail and a second side rail, wherein each side rails may be parallel to the length of the horizontal support, and wherein the side rails may be each secured to a first outer edge of the first panel and a second outer edge of the second panel respectively.

Preferably, the first side rail and the second side rail may be each positioned above the level of the mattress, when the mattress may be received on the horizontal surface.

Preferably, the horizontal surface may further comprise an inclinable upper panel positioned between the length of the first panel and the length of the second panel, wherein the upper panel can selectively incline transverse to the length of the horizontal surface by the at least one actuator, and wherein when the upper panel is inclined, the inclining upper panel allows for movement of supine person towards a seated position.

Preferably, the horizontal surface formed by the surfaces of the first panel, the second panel, and the upper panel may have a rectangular profile.

Preferably, the at least one actuator may incline the upper panel above the level of the horizontal surface when the first panel and the second panel may be level to the horizontal surface.

Preferably, the angle between the upper panel and the length of the horizontal surface may be between 180° to 90°.

Preferably, the rate of inclining of the upper panel may be between 2° to 8° per second.

Preferably, the at least one actuator may incline the first panel, when the second panel and the upper panel may be level to the horizontal surface.

Preferably, the at least one actuator may incline the second panel, when the first panel and the upper panel may be level to the horizontal surface.

Preferably, the horizontal surface may be height adjustable.

Preferably, the at least one actuator may be in communication with a controller, wherein the controller may be configured to control inclining speed of any one of the panels or adjusting the height of the horizontal surface.

Preferably, the at least one actuator may be in wireless communication with the controller.

Preferably, the first panel may be selectively inclined by a first actuator, and wherein the second panel is selectively inclined by a second actuator.

Preferably, the upper panel may be selectively inclined by a third actuator.

Preferably, the height of the horizontal surface may be selectively adjusted by a fourth actuator.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 illustrates a perspective view of the bed with the first panel, second panel, and upper panel being level to the horizontal surface, in which the horizontal surface has been elevated.

FIG. 2 illustrates another perspective view of the bed of FIG. 1, in which the horizontal surface has been lowered.

FIG. 3 illustrates a bottom perspective view of the bed of FIG. 1, showing the at least one actuator used for effecting the selective inclination of the panels.

FIG. 4 illustrates a perspective view of the bed of either FIG. 1 or FIG. 2, showing an inclination of the first panel or right panel.

FIG. 5 illustrates a side perspective view of the bed of FIG. 4 showing the at least one actuator used in inclining the first panel.

FIG. 6 illustrates another perspective view of the bed of either FIG. 1 or FIG. 2, showing an inclination of the second panel or left panel.

FIG. 7 illustrates another perspective view of the horizontal surface, showing an inclination of the first panel and the second panel.

FIG. 8 illustrates a side perspective view of the bed of FIG. 7, showing the at least one actuator used in inclining the first panel and the second panel.

FIG. 9 illustrates a perspective view of the bed of either FIG. 1 or FIG. 2, showing an inclination of the upper panel.

FIG. 10 illustrates a bottom perspective view of the bed of FIG. 9, showing the at least one actuator used in inclining the upper panel.

FIG. 11 illustrates a bed with an inclined upper panel, showing the bed having a flexible mattress with the first patient support and the second patient support are secured to the edge of the first panel and the edge of the second panel respectively. The first patient support proximal to a supine patient's right hand allows for a supine person's right hand to hold onto, while the second patient support proximal to a supine person's left hand allows for the supine patient's left hand to hold onto.

FIG. 12 illustrates a bed with a supine patient, showing an inclination of the left panel or second panel for allowing lateral rotation of supine patient onto their side.

FIG. 13 illustrates an illuminable handset for illumining certain configurations of the bed when the panels have tilted to correspond with the configuration.

FIG. 14 illustrates a perspective view of another preferred embodiment of the bed showing that the horizontal surface can be able to be lowered to a small distance above the level surface of the floor.

FIG. 15 illustrates a partial perspective view of another preferred embodiment of the bed having rounded edges and/or corners of the horizontal surface.

### DESCRIPTION OF THE INVENTION

Preferred embodiments of the invention will now be described with reference to the accompanying drawings and non-limiting examples.

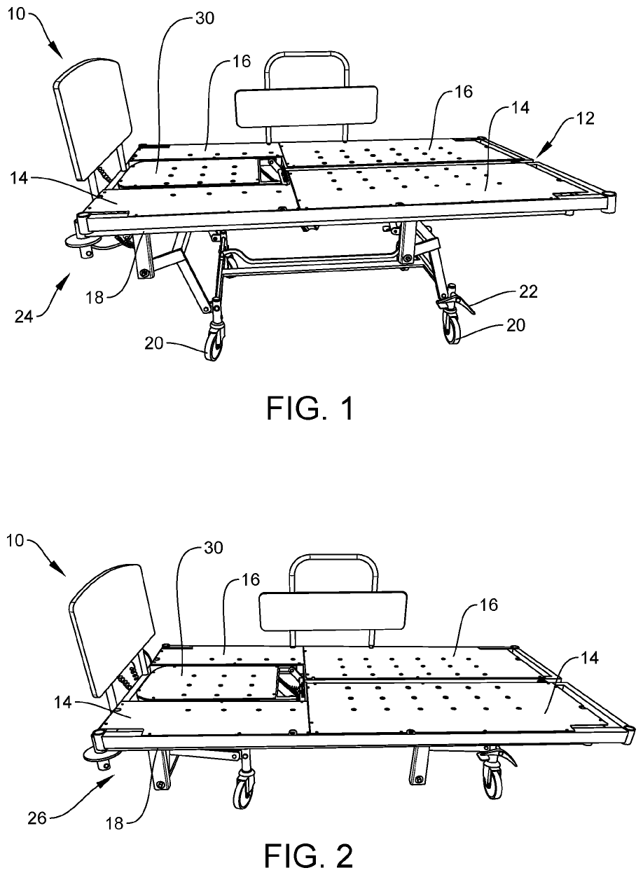

In an embodiment of the present invention, as illustrated in FIGS. 1 to 12, FIG. 1 shows a bed 10 for turning a supine patient according to a preferred embodiment of the present invention. The bed 10 may comprise a horizontal surface 12. The horizontal surface 12 may be a generally be an elongated rigid body or support. The horizontal surface 12 may be level and may be adapted for receiving a mattress 13. The horizontal surface 12 may comprise a first panel 14 and a second panel 16 extending along the length of the surface 12. Preferably, the length of the first panel 14 extends along the entire length of the surface 12, and the length of the second panel 16 also extends along the entire length of the surface 12. As a supine patient may have their right side of the body resting on the first panel 14, and their left side of the body resting on second panel 16; the first panel 14 may also be a right panel 14 and the second panel 16 may also be a left panel 16.

The horizontal surface 12 may be in connection with a sturdy surface frame 18 that is engageable to the ground or floor for supporting the predetermined weight of a supine patient when the supine patient is resting on the horizontal surface 12 of the bed 10. For ease of moving the bed 10, the surface frame 18 may have wheels 20 with a wheel lock mechanism 22 for resisting movement of the bed 10 along the floor, when the bed 10 is situated at a desired place. FIG. 1 illustrates the horizontal surface 12 at an elevated configuration 24 and FIG. 2 illustrates the horizontal surface 12 at a lowered configuration 26. An advantage of having an elevated configuration 24 is that the supine person may be more comfortable and not be breathing near a dirty or dusty ground when resting. The lowered configuration 26 may allow a supine patient with restricted and/or limited mobility to easily access the bed 10 when going onto the bed 10 or easily access the floor when getting out of the bed 10.

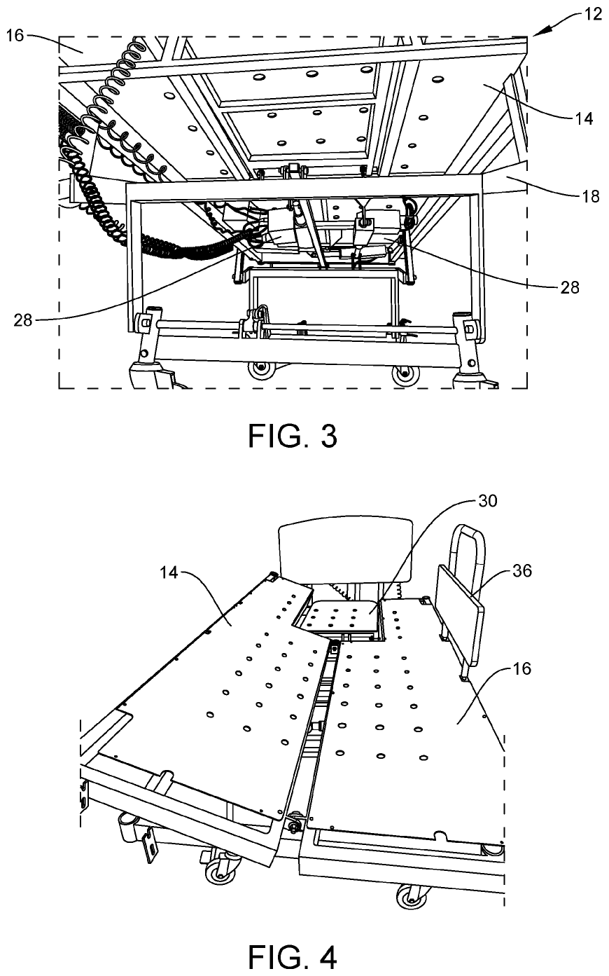

As illustrated in FIG. 3, there may be an actuator 28 or one or more different actuators 28 positioned underneath the supine patient receiving surface of the horizontal surface 12. The actuator 28 may actuate the surface frame 18 such that the height or level of the horizontal surface 12 can be adjusted. The actuator 28 or one or more different actuators 28 may also be able to selectively incline the first panel 14 and the second panel 16. In one embodiment of the present invention, it may be appreciated that the bed 10 may only be for turning a supine patient on their respective sides, as shown in FIG. 12, where the entire length of the panel may apply a torsional force to the respective side of supine patient. That is, for example, when the left panel 16 is being inclined by the actuator 28, the entire left side of the supine patient, from the left side of the shoulders down to the left leg are all being laterally rotated with the inclining left panel 16. Similarly, when the right panel 14 is being inclined by the actuator 28, the entire right side of the supine patient, from the right side of the shoulders down to the right leg are all being laterally rotated with the inclining right panel 14. This present invention thereby aims to turn or roll the entire person on their respective sides to a desired angle between 180° to 90° from the first panel 14 and the second panel 16. Advantages of using the entire length of the panel 14/16 to incline a supine patient is that the supine patient does not require to exert as much physical strength in rolling. There is no exertion required on the part of the patient/resident. As opposed to turning apparatuses that move the supine patient by their shoulders or hips, the patient then exerts physical torsional force to drag or turn their legs in the same direction. This may increase the risk of the immobile or supine patient overexerting or over stretching muscles in their body when turning.

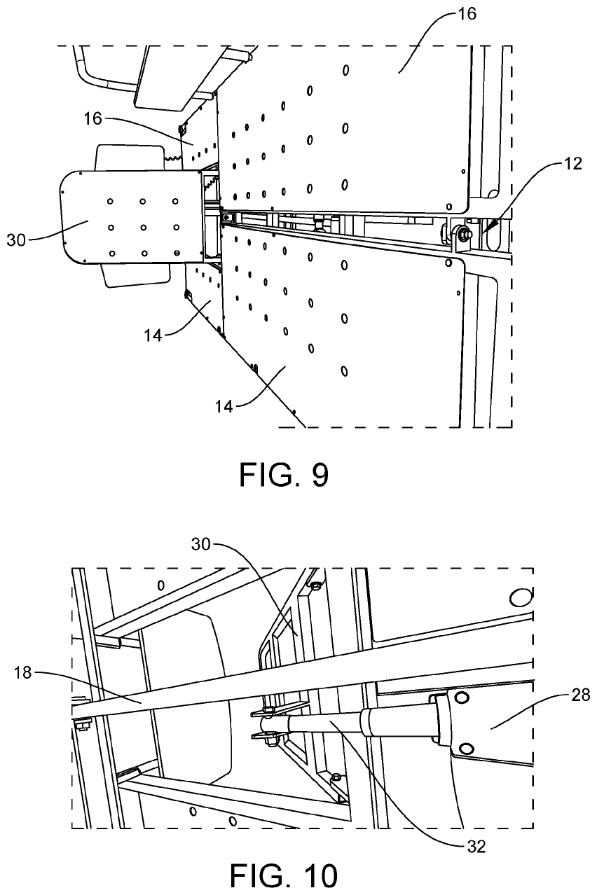

The horizontal surface 12 may comprise the first panel 14 and the second panel 16. In another embodiment, as shown in FIG. 9, besides the horizontal surface 12 comprising the first panel 14 and the second panel 16, it may be preferrable to also have an inclinable upper panel 30 transverse to the length of the horizontal surface 12. As shown in FIG. 10, the actuator 28 or another actuator can be used to effect the inclination of the upper panel 30 such that the angle between the upper panel 30 and the length of the horizontal surface is between 180° to 90°. The actuator 28 may have at least one extendable arm 32 that allows for the inclination of the panel. The extendable arm 32 can be retractable so that the inclined panel can be move back towards the level of the horizontal surface 12. The upper panel 30 may be adapted to receive the head and a portion of the supine patient's upper body. An advantage of having a transversely inclinable upper panel 30 is so that a supine patient with restricted and/or limited mobility can be assisted to be from a supine position towards an upright position.

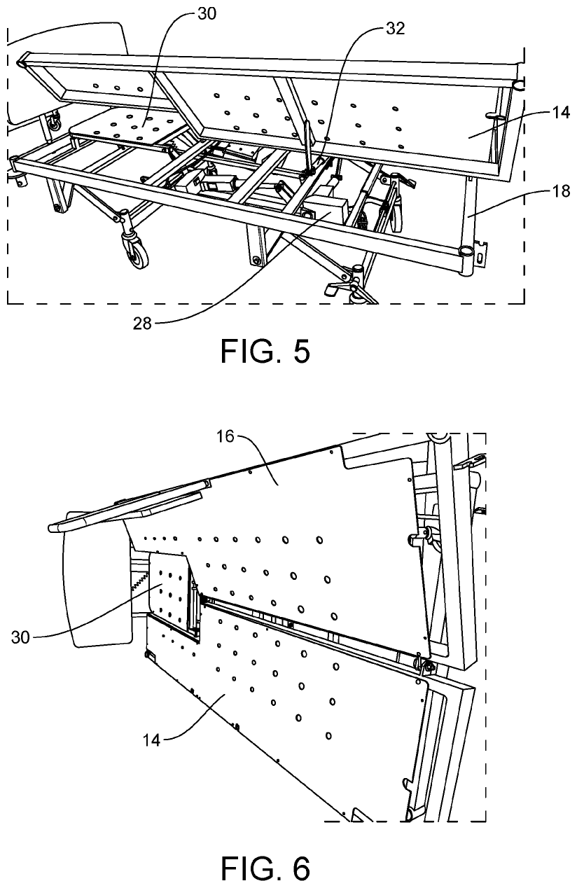

As shown in FIG. 4, the first panel 14 or the right panel 14 may be selectively inclined by an actuator 28 or another actuator, which is shown in FIG. 5. As shown in FIG. 6, the second panel 16 or the left panel 16 may be selectively inclined by the actuator 28 or another actuator. The actuator 28 may incline each panel 14, 16 above the level of the horizontal surface such that the angle between the first panel 14 and the second panel 16 is between 180° to 90°. As illustrated in FIGS. 4 and 6, the at least one actuator 28 can incline one of the panels 14/16 when the other panel 16/14 is level to the horizontal surface 12. For the embodiment when there is an upper panel 30, the upper panel 30 is also level to the horizontal surface when one of the panels 14/16 are inclining. For safety reasons, the other panels have to be level to horizontal surface when one of the panels are inclining is so that the supine patient will not be squashed or hurt between two inclining panels. The bed 10 may further comprise a person sensor and/or weight sensor for determining whether there may be flexible mattress 13 and/or a supine patient on the flexible mattress 13. When the flexible mattress 13 and/or a person is/are sensed to be on the horizontal surface 12, the actuator 28 or actuators 28 responsible for inclining a panel will only allow one panel to incline and disable the actuation of another panel from inclining.

The mattress 13 may be a flexible mattress 13 for allowing the mattress 13 to fold when any of the panels are inclining or inclined, and the mattress 13 may be secured to the horizontal surface 12 so that the mattress can be held in place over the rectangular horizontal surface 12. Preferably, the rate of inclining one of the panels 14/16 is between 2° to 8° per second. It may be appreciated that the rate of inclination be smooth and not too fast so that the supine patient does not feel like that it is a jolt or a forceful movement to laterally rotate onto the desired respective side or towards an upright seated position. Similarly, the rate of inclining of the upper panel is also between 2° to 8° per second.

As shown in FIGS. 1, 4, and 6, the bed 10 may further comprise a first side rail 34 and a second side rail 36, wherein each of the side rails 34/36 are parallel to the length of the horizontal support 12, and wherein the side rails 34/36 are each secured to a first outer edge 38 of the first panel 14 and a second outer edge 40 of the second panel 16 respectively. It may be appreciated that the first side rail 34 may have a length corresponding along the length from the right shoulder to the right hip of the supine resident/patient; and similarly, the second side rail 36 may have a length corresponding along the length from the left shoulder to the left hip of the supine resident/patient. The side rails 34, 36 are for allowing a supine patient's arm to grip or hold onto when the supine patient is being laterally rotated onto their side so that the supine patient does not roll off the bed 10. Or the side rails 34, 36 are for allowing a supine patient's arm to grip or hold onto when the patient is either getting onto the bed 10 or getting off the bed 10.

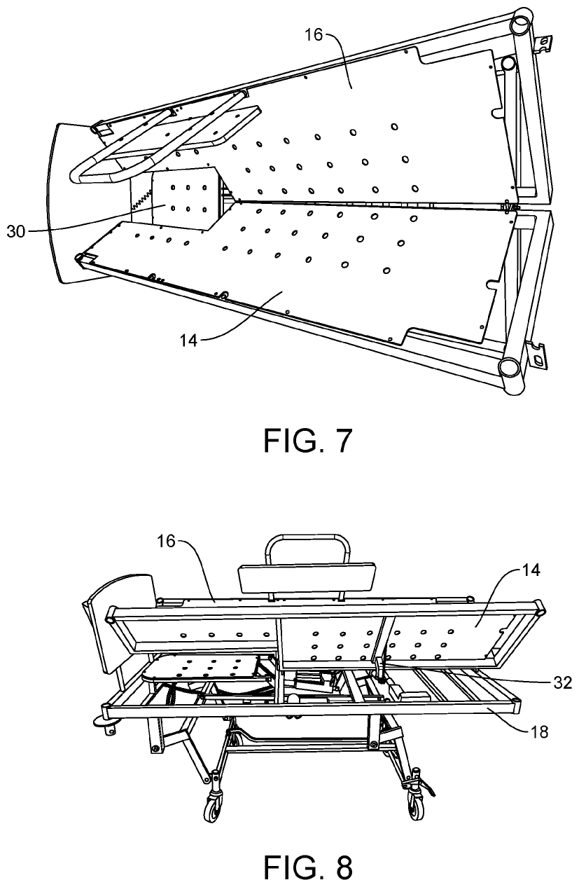

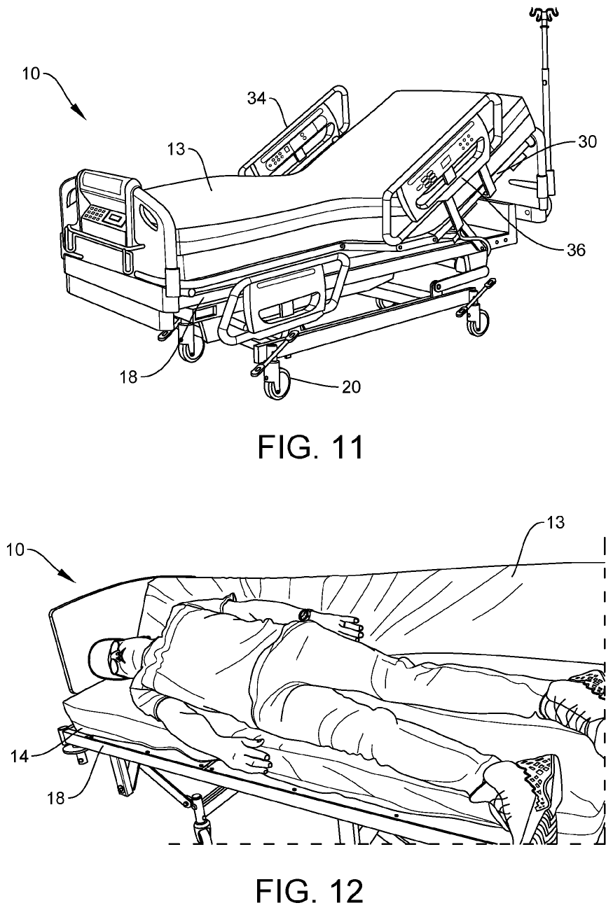

As shown in FIG. 7 and FIG. 8, in another embodiment of the present invention, both the first and second panels 14, 16 can be inclined as a safety feature when a supine patient may feel that they are rolling off the bed from the side when one of the panels may be near 90° so the other panel may also be slightly inclinable to prevent the patient to fall. There may also be a gentle rocking setting, as one panel may decline as the other panel may incline. In this rocking setting, the angle between the two inclined panels 14, 16 may be between 180° and 120° so that the supine resident/patient will not feel squashed between two inclinable panels 14, 16. As shown in FIG. 11, the bed 10 is illustrated with the foldable mattress 13 and the side rails 34, 36. There may be controls 42 at the side rails which would be where the hands of the supine patient may reach for personal adjustment and comfort purposes. Or the controls 42 can be positioned such that a nurse or a caretaker can adjust the panels of the bed according to the needs of the supine patient. The actuator 28 or the at least one actuator 28 may be in communication or wireless communication with a controller 44, wherein the controller may be configured to control inclining speed of any one of the panels or adjusting the height of the horizontal surface 12.

While it may be appreciated that one actuator 28 having different extendable arms 32 for controlling different panels can be used, in another embodiment of the present invention, the first panel 14 may be selectively inclined by a first actuator 46, and wherein the second panel 16 may be selectively inclined by a second actuator 48. The upper panel 30 may be selectively inclined by a third actuator 50, and the height of the horizontal surface 12 may be selectively adjusted by a fourth actuator 52. It may be appreciated that the bed may have pressure sensors, for example a piezoelectric sensor (not shown) that would identify whether a person is on the bed 10 or not. The lateral tilt actuator speed may be between 7.5 mm/s to 20 mm/s when there is no load on the bed to allow the operator to quickly get the panels into the desired configuration or position faster for patient loading, and wherein the load sensor have sensed that a person is on the bed, the lateral tilt actuator speed may be a lot slower such as a speed between 4 mm/s to 7.5 mm/s for patient comfort and to reduce risk of the patient feeling a quick sudden tilting movement.

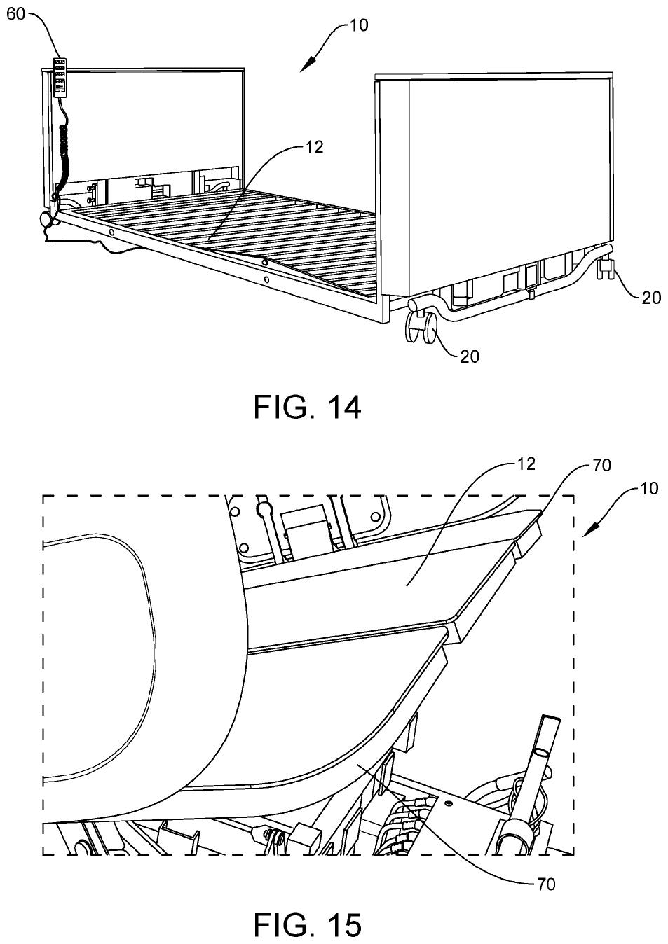

As shown in FIG. 14, it may be appreciated that the horizontal surface 12 may be adjusted to as low as 100 mm or lower above the level surface of the floor. The horizontal surface at the lowest level is advantageous so as to allow a patient carried or stretchered to the bed 10 in a supine position to be easily transferred to the bed 10 in a similar position as it may minimise substantial movement to the patient, who may be in substantial pain or injury. Further advantages of lowing the horizontal surface 12 of the bed 10 to such a level is so that it significantly decreases the risk of fall or pressure on the patient's feet as the potential energy of the patient disembarking from the bed is much lower compared to the horizontal surface being at a higher distance above the level surface of the floor. It may also minimise the risk of injury in the case that the patient accidentally falls to the ground from the bed 10 when it is at the lowest level.

As shown in FIG. 15, for further reducing the possibility of injury to the patient when embarking or disembarking from the bed 10, the corners 70 of the horizontal surface 12 at the ends are curved or having rounded edges. As patients using the bed 10 may be mobility challenged, there is a higher likelihood of the patient bumping into the corners of the bed 10. As such, while there is a chance that the patient may bump or collide with a rounded corner 70, when the edges are rounded as opposed to sharp rectangular corners, it may reduce the prospect of further injury.

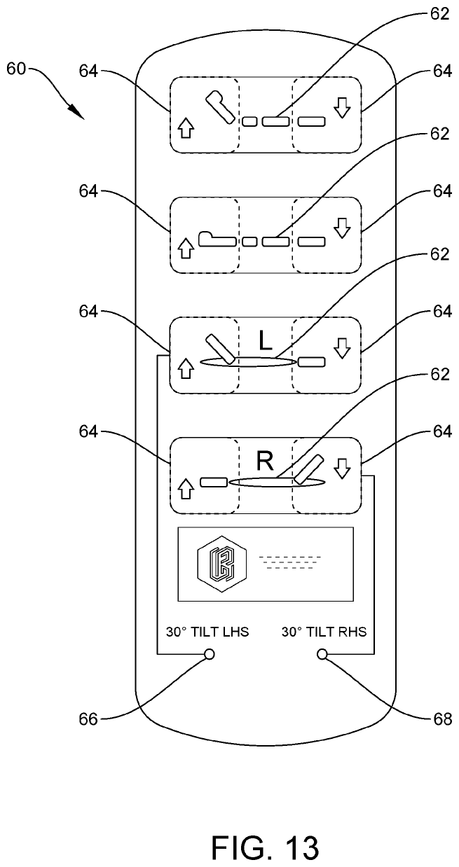

As shown in FIG. 13, it may be appreciated that a handset 60 is in communication with the actuators. The handset may show the configuration(s) 62 of the bed 10 when panels are adjusted or moved to a predetermined degree away from the horizontal and the illuminable buttons 64 allow for simple identification of the panels that are undergoing movement and/or at the illustrated configuration.

For example, lights on the handset may illustrate once either the left-hand side 66 or right-hand side 68 of the horizontal surface 12 or mattress platform 12 is elevated to a predetermined degree, for example, to 30°. When reached, the actuator(s) responsible for moving the specific panel(s) may pause for a predetermined time, for example between the range of 1 to 4 seconds before continuing. The time pause may allow the carer or the patient to have sufficient reaction time to stop the panels from tilting further, if necessary, as it may be too steep for the patient. And by pausing, the patient will know that it has reached the predetermined tilt angle. It may be appreciated that the handset may be controlled remotely and automation may assist the carer to allow quick and efficient adjustments as required for different patients in the same ward. In a preferred embodiment of the invention, automation software may allow a reading to be taken from the control box showing the actuator actions which have been performed during a specific period. The automation may allow a light from the handset to illuminate at the bottom end of the bed 10 (such as a ‘turn aware light’) for a predetermined time period. The predetermined time period may be every 2, 3, or 4 hours to prompt the nurse or carer to turn the patient either left or right. The hardware may have a 24-hour timer linked to the control box, in which the timer may be programmed to suit the specific patient's needs. The light may be configured to not go off until the horizontal surface 12 or the mattress platform 12 has been rotated either left or right, up or down a minimum of 30° from the longitudinal axis of the horizontal surface. It may be appreciated that an extended care mode be allowed to communicate with the handset and actuators of the bed. For security, the extended care mode for allowing the nurse or carer to control the movement of the panels will have to enter an access code/user verification to allow access and operation of the extended care mode.

The additional hardware and software may or may not be a stand alone unit which may or may not be connected to the main control box. The main control box (not shown) may work as a main controller that provides connectivity to all the hardware devices found in a room or a patient ward or a large facility to provide centralized control directly and effortlessly using a controller or a mobile device, or a tablet computer etc. The control system application may then connect to the control box from any one of iOS, Android or Windows mobile device/tablet computer which may allow the user or carer to control all the hardware devices, in different rooms at their discretion. The control box may serve as the central platform where the hardware devices are connected, which may be monitored, managed and controlled directly via a bespoke graphical user interface from any one of IOS, Android or Windows mobile device. To provide control of the hardware devices, viewer profiles may provide a customised control graphical user interface to grant the authorised user quick access to specific control hardware devices associated to the moveable bed. For additional security of the system and to ensure the authorised user or carer is in control of operating the system, the profile is protected with at least one authentication means. The authentication means may be password and/or biometric.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A bed adapted for turning a supine patient, the bed comprising:
a horizontal surface adapted for receiving a mattress;
the horizontal surface comprises a first panel and a second panel extending along the length of the surface, wherein each panel can selectively incline by at least one actuator and wherein when one of the panels is inclining, the inclining panel allows for lateral rotation of supine patient onto their respective side;
wherein the horizontal surface further comprises an inclinable upper panel positioned between the length of the first panel and the length of the second panel, wherein the upper panel can selectively incline transverse to the length of the horizontal surface by the at least one actuator;
the at least one actuator can incline the upper panel above the level of the horizontal surface when the first panel and the second panel are level to the horizontal surface; and wherein when the upper panel is inclined, the inclining upper panel allows for movement of supine person towards a seated position.

2. The bed according to claim 1, wherein the actuator inclines each panel above the level of the horizontal surface such that the angle between the first panel and the second panel is between 180° to 90°.

3. The bed according to claim 0, wherein the at least one actuator can incline one of the panels when the other panel is level to the horizontal surface.

4. The bed according to claim 1, wherein the rate of inclining one of the panels is between 2° to 8° per second.

5. The bed according to claim 1, wherein the mattress is flexible.

6. The bed according to claim 5, wherein the bed further comprises a first side rail and a second side rail, wherein each side rails are parallel to the length of the horizontal support, and wherein the side rails are each secured to a first outer edge of the first panel and a second outer edge of the second panel respectively.

7. The bed according to claim 6, wherein the first side rail and the second side rail are each positioned above the level of the mattress, when the mattress is received on the horizontal surface.

8. The bed according to claim 1, wherein the horizontal surface formed by the surfaces of the first panel, the second panel, and the upper panel has a rectangular profile.

9. The bed according to claim 1, wherein the angle between the upper panel and the length of the horizontal surface is between 180° to 90°.

10. The bed according to claim 9, wherein the rate of inclining of the upper panel is between 2° to 8° per second.

11. The bed according claim 1, wherein the at least one actuator can incline the first panel, when the second panel and the upper panel are level to the horizontal surface.

12. The bed according to claim 1, wherein the at least one actuator can incline the second panel, when the first panel and the upper panel are level to the horizontal surface.

13. The bed according to claim 1, wherein the horizontal surface is height adjustable.

14. The bed according to claim 1, wherein the at least one actuator is in communication with a controller, wherein the controller is configured to control inclining speed of any one of the panels or adjusting the height of the horizontal surface.

15. The bed according to claim 14, wherein the at least one actuator is in wireless communication with the controller.

16. The bed according to any claim 1, wherein the first panel is selectively inclined by a first actuator, and wherein the second panel is selectively inclined by a second actuator.

17. The bed according to claim 16, wherein the upper panel is selectively inclined by a third actuator.

18. The bed according to claim 16, wherein the height of the horizontal surface is selectively adjusted by a fourth actuator.
